(19) United States
(12) Patent Application Publication
(10) Pub. No.: US 2008/0226097 A1
(43) Pub. Date: Sep. 18, 2008

(54) Filter Circuit and Reproduction Device Using the Same

(76) Inventor: Takashige Miyashita, Kyoto (JP)

Correspondence Address: CANTOR COLBURN, LLP, 20 Church Street, 22nd Floor, Hartford, CT, 06103, US

(21) Appl. No.: 10/591,876

(22) PCT Filed: Mar. 4, 2005
(86) PCT No.: PCT/JP2005/003737

§ 371 Date: May 19, 2008

(30) Foreign Application Priority Data
Mar. 5, 2004 (JP) 2004-063090

(51) Int. Cl. H04B 15/00; H04B 1/10

(52) U.S. Cl. 381/94.1; 455/307

(57) ABSTRACT

A low-pitched sound which cannot be reproduced by a speaker is cut off. An operational amplifier A1, a capacitor C2 and a capacitor C3 output a signal in which a signal with band-pass characteristics is inverted. A switch S3 operates as a resistor and inverts a signal outputted from the operational amplifier A1. An operational amplifier A2 and a capacitor C6 output a signal with low-pass characteristics. Furthermore, the signal with low-pass characteristics is fed back to the operational amplifier A1 via a switch S4 and a capacitor C4. An operational amplifier A3, resistors R1 to R4 and a capacitor C7 attenuate a signal component with low-pass characteristics and a signal component with band-pass characteristics from an input signal and extract a signal with high-pass characteristics in the input signal.

### CROSS-REFERENCE TO RELATED APPLICATIONS

This is a U.S. national stage of application No. PCT/JP2005/003737, filed on 4 Mar. 2005. Priority under 35 U.S.C. §119(a) and 35 U.S.C. §365(b) is claimed from Japanese Application No. 2004-063090, filed 5 Mar. 2004, the disclosure of which is also incorporated herein by reference.

### BACKGROUND OF THE INVENTION

1. Field of the Invention

The present invention relates to the filter technology and it particularly relates to a filter circuit that allows the passage of signals with a high-pass frequency band and a reproduction apparatus utilizing the same.

2. Description of the Related Art

In recent years, the liquid crystal television receivers, plasma display television receivers and the like are appearing on the market as if they were to replace the CRT television receivers. The emergence of such television receivers accelerates the trend of larger and thinner screens in the television receivers. Under such circumstance, the restrictions imposed on the size of enclosure of a speaker mounted on a television receiver and the mounting position thereof are increasing and in particular the enclosure tends to be even smaller in size. In general, the smaller the enclosure, more difficult it is to reproduce rich low-pitched sound and achieve the realistic sensation. As a result, the manufacturers that manufacture speakers and liquid crystal television receives cannot help but manufacture speakers where the sound quality to be reproduced are reduced. At the same time the users who use the speakers and liquid crystal television receivers are forced to hear the audio with low sound quality (See Nonpatent Reference (1), for instance).

### [Nonpatent Reference (1)]

Tamon Sahaku, Editorial supervisor, “(New Edition) Speaker and Enclosure Encyclopedia”, Seibundo-Shinkousha, p. 27, May 1999.

The inventor of the present invention had come to recognize the following problems to be solved. As discussed above, in a speaker whose enclosure capacity is small, it is difficult to reproduce the audio lower than a predetermined frequency (hereinafter, the frequency capable of being reproduced by a speaker will be referred to as “reproducible frequency”). Conventionally, in order to reproduce the audio lower than the predetermined frequency, the amplification is done at a gain larger than the other frequency bands. A preamplifier for amplification provided at a stage preceding to a speaker amplifies the signals including those with very low frequency, so that the bass distortion as a result of a drive of the speaker will also be amplified. As a result, the sound quality of audio reproduced by the speaker will be further degraded. In the light of this, the inventor focused attention on the sound quality of audio reproduced by the speaker and had arrived at an idea of cutting off the audio whose frequency is lower than a predetermined frequency the reproduction of which is difficult by the speaker.

Furthermore, in a speaker where the enclosure's capacity is small, it is generally required that a reproducing device attached to the speaker, such as a preamplifier, be smaller in size. In a case when a high-pass filter is provided to remove a signal with a frequency lower than the above-described reproducible frequency of the speaker, it is also required that the high-pass filter be made smaller in size and, in particular, made into an IC. One of filters suitable for IC packaging is a filter using a switched-capacitor equivalent circuit. However, if the frequency of a signal passed through said filter becomes higher to some extent as compared with the sampling frequency of a switched-capacitor equivalent circuit, the signal will suffer from distortion caused by the effect of the sampling frequency and therefore the quality of signals passed through said filter deteriorates.

### SUMMARY OF THE INVENTION

The present invention has been made in view of these problems and an object thereof is to provide a filter circuit by which to cut off a signal with a frequency band that cannot be reproduced by a speaker whose enclosure volume is small, and a reproduction apparatus utilizing said filter circuit.

One embodiment of the present invention relates to a filter circuit. This circuit comprises: an input unit which inputs a signal to be processed; a first extraction unit which passes the inputted signal through a filter and which extracts a signal with low-pass characteristics and a signal with band-pass characteristics in the inputted signal; and a second extraction unit which attenuates a component of the extracted signal with low-pass characteristics and a component of the extracted signal with band-pass characteristics from the inputted signal and which extracts a signal with high-pass characteristics in the inputted signal. In this circuit the first extraction unit is comprised of a switched-capacitor equivalent circuit which is to operate a resistor contained in the filter at a predetermined sampling frequency, said sampling frequency is set to a frequency higher than a reproducible frequency of a speaker provided at a subsequent stage, and the filter is so set as to extract the signal with low-pass characteristics and the signal with band-pass characteristics to be cut off by a frequency in the vicinity of the reproducible frequency of a speaker and, based on the signal with low-pass characteristics and the signal with band-pass characteristics, the second extraction unit may extract the signal with high-pass characteristics whose frequency is equal to or higher than the reproducible frequency of a speaker.

The “reproducible frequency of a speaker” is a frequency at which the speaker can reproduce the sound of excellent quality, and its limit is specified by a “reproduction limit frequency of a speaker” which is the lower of the frequency at which the output of the speaker becomes smaller.

With the above circuit, a switched-capacitor equivalent circuit is used for the biquad filter, so that the size can be reduced. Since a signal with band-pass characteristics and a signal with low-pass characteristics are extracted by a biquad filter that contains a switched-capacitor equivalent circuit, there results no effect of distortion by the sampling at the switched-capacitor equivalent circuit. Furthermore, since the frequency to be cut off is set as the vicinity of the reproducible frequency of a speaker, the effect of distortion on the reproduced audio can be suppressed.

A filter in the first extraction unit may be a biquad filter. The biquad filter in the first extraction unit may includes: a first switched-capacitor equivalent circuit which allows passage of the inputted signal; a first operation amplifier which extracts the signal with band-pass characteristics from the signal passed through the first switched-capacitor equivalent circuit; a second switched-capacitor equivalent circuit which allows passage of the extracted signal with band-pass characteristics; a second operation amplifier which extracts the signal with low-pass characteristics from the signal passed through the second switched-capacitor equivalent circuit; and a third switched-capacitor equivalent circuit which allows passage of the extracted the signal with low-pass characteristics and feeds back the signal passed therethrough to the first operational amplifier, wherein when the first switched-capacitor equivalent circuit and the second switched-capacitor equivalent circuit invert the phase of the signal passed therethrough, the third switched-capacitor equivalent circuit may be so structured as not to invert the phase of the signal passed therethrough; and when the first switched-capacitor equivalent circuit and the second switched-capacitor equivalent circuit do not invert the phase of the signal passed therethrough, the third switched-capacitor equivalent circuit may be so structured as to invert the phase of the signal passed therethrough.

The reproducible frequency of a speaker which is to serve as a reference for the sampling frequency in the first extraction unit may be determined according to an enclosure volume of the speaker, and as the enclosure of the speaker becomes smaller, the biquad filter may be so set as to raise the frequency at which the signal with low-pass characteristics and the signal with band-pass characteristics are to be cut off.

Another embodiment of the present invention relates also to a filter circuit. This circuit comprises: an input unit which inputs a signal to be processed; a first extraction unit which passes the inputted signal through a first-order incomplete integrator and which extracts a signal with low-pass characteristics in the inputted signal; and a second extraction unit which attenuates a component of the extracted signal with low-pass characteristics from the inputted signal and which extracts a signal with high-pass characteristics in the inputted signal. In this circuit, the first extraction unit may be comprised of a switched-capacitor equivalent circuit which is to operate a resistor, contained in the first-order incomplete integrator, at a predetermined sampling frequency, said sampling frequency may be set to a frequency higher than a reproducible frequency of a speaker provided at a subsequent stage, and the first-order incomplete integrator may be so set as to extract the signal with low-pass characteristics to be cut off by a frequency in the vicinity of the reproducible frequency of a speaker and, based on the signal with low-pass characteristics, the second extraction unit may extract the signal with high-pass characteristics whose frequency is equal to or higher than the reproducible frequency of a speaker.

With the above circuit, a switched-capacitor equivalent circuit is used for the first-order incomplete integrator, so that the size can be reduced. Since a signal with low-pass characteristics is extracted by a first-order incomplete integrator that contains a switched-capacitor equivalent circuit, there results no effect of distortion by the sampling at the switched-capacitor equivalent circuit. Furthermore, since the frequency to be cut off is set as the vicinity of the reproducible frequency of a speaker, the effect of distortion on the reproduced audio can be suppressed.

It may further comprise a control unit which controls the frequency, in the vicinity of the reproducible frequency of a speaker, to be cut off by the first extraction unit. It may further comprise: a receiving unit which receives from a user an instruction on the frequency, in the vicinity of the reproducible frequency of a speaker, to be cut off by said first extraction unit; and a conversion unit which converts the received instruction into a digital data word, wherein, based on the digital data word converted, the control unit may control the frequency, in the vicinity of the reproducible frequency of a speaker, to be cut off by the first extraction unit.

Still another embodiment of the present invention relates to a filter circuit. This circuit includes one or more first-order high-pass filters and one or more second-order high-pass filters. In this circuit, the second-order high-pass filter may extract a signal with low-pass characteristics and a signal with band-pass characteristics and attenuate a component of the extracted signal with low-pass characteristics and a component of the extracted signal with band-pass characteristics so as to extract a signal with high-pass characteristics, and the second-order high-pass filter may include a resistor comprised of a switched-capacitor equivalent circuit which is to operate at a predetermined sampling frequency; the first-order high-pass filter may extract a signal with high-pass characteristics by a first-order incomplete integrator and attenuate a component of the extracted signal with low-pass characteristics so as to extract a signal with high-pass characteristics, and the first-order high-pass filter may be comprised of a switched-capacitor equivalent circuit which is to be operate a resistor, included in the first-order incomplete integrator, at a predetermined sampling frequency; and the sampling frequency to be set in the one or more first-order high-pass filters and the one or more second-order high-pass filters may be set to a frequency higher than a reproducible frequency of a speaker provided at a subsequent stage, and the one or more first-order high-pass filters and the one or more second-order high-pass filters may be connected in series and extract the signal with high-pass characteristics whose frequency is equal to or higher than the reproducible frequency of a speaker. The second-order high-pass filter may include a biquad filter.

Still another embodiment of the present invention relates to a reproduction apparatus. This reproduction apparatus comprises: an input unit which inputs a signal to be processed; a high-frequency extraction unit which extracts, from the inputted signal, a signal with high-pass characteristics whose frequency is equal to or higher than a reproducible frequency of a speaker provided at a subsequent stage; an amplification unit which amplifies the extracted signal with high-pass characteristics; and a speaker which reproduces the amplified signal as an audio signal. In this apparatus, the high-frequency extraction unit includes: a first extraction unit which passes the inputted signal through a filter and which extracts a signal with low-pass characteristics and a signal with band-pass characteristics in the inputted signal; and a second extraction unit which attenuates a component of the extracted signal with low-pass characteristics and a component of the extracted signal with band-pass characteristics from the inputted signal and which extracts a signal with high-pass characteristics in the inputted signal, wherein the first extraction unit is comprised of a switched-capacitor equivalent circuit which is to operate a resistor contained in the filter is to be operated at a predetermined sampling frequency, said sampling frequency may be set to a frequency higher than a reproducible frequency of said speaker, and the filter may be so set as to extract the signal with low-pass characteristics and the signal with band-pass characteristics to be cut off by a frequency in the vicinity of the reproducible frequency of said speaker and wherein, based on the signal with low-pass characteristics and the signal with band-pass characteristics, the second extraction unit may extract the signal with high-pass characteristics whose frequency is equal to or higher than the reproducible frequency of the speaker.

It is to be noted that any arbitrary combination of the aforementioned constituent elements and the expression of the present invention changed among a method, an apparatus, a system and so forth is also effective as the embodiments of the present invention.

### BRIEF DESCRIPTION OF THE DRAWINGS

FIG. 1 is a block diagram showing a structure of an audio output apparatus according to a first embodiment of the present invention.

FIG. 2 shows a diagram showing a frequency characteristic of an equalization circuit shown in FIG. 1.

FIG. 3 is a block diagram showing a structure of an equalization circuit shown in FIG. 1.

FIG. 4 shows a relation of the frequency characteristics to the phase shift in a preceding-stage low-pass filter and a subsequent-stage low-pass filter shown in FIG. 1.

FIGS. 5A to 5C show frequency characteristics of an equalization circuit.

FIG. 6 is a block diagram showing a structure of a first high-frequency extraction unit according to a second embodiment of the present invention.

FIGS. 7A and 7B are diagrams showing frequency characteristics at P10 to P16 of FIG. 6.

FIG. 8 shows frequency characteristics of a single-cone full-range speaker.

FIG. 9 is a block diagram showing a structure of a high-frequency extraction unit according to a third embodiment of the present invention.

FIG. 10 is a block diagram showing a structure of a first-order high-pass filter of FIG. 9.

FIG. 11 is a block diagram showing a structure of an audio output apparatus according to a fourth embodiment of the present invention.

### DETAILED DESCRIPTION OF THE INVENTION

### First Embodiment

An outline of the present invention will be given before a specific description thereof. A first embodiment of the present invention relates to an audio reproduction apparatus that reproduces audio in a flat-panel television receiver. Due to the constraint imposed upon the shape of the flat-panel television receiver, it is assumed herein that the enclosure of a speaker contained in the audio reproduction apparatus is small and, as a result thereof, the reproduction limit frequency is high. Since in the audio reproduction apparatus according to the present embodiment it is intended to improve the sound quality of low-pitched sound, a signal with a frequency lower than the reproduction limit frequency also needs to be outputted under a certain level of sound pressure. At the same time, it is desired that the sound pressure of bass distortion contained in the low frequency domain in a bass region be inhibited. In order to solve the above problem, the audio reproduction apparatus includes an equalization circuit. The equalization circuit solves the above-described technical problems and, for the purpose of reducing the effect on the vocal band and the dip, the equalization circuit operates as follows. The equalization circuit inputs a plurality of signals corresponding to the stereo output, and removes the bass region of the plurality of signals inputted. Thereby, the bass distortion is prevented. The plurality of signals whose bass distortion has been removed are inputted to both a high-frequency extraction unit and a low-frequency extraction unit.

The high-frequency extraction unit extracts components of a signal whose frequency is equal to or greater than the reproduction limit frequency. That is, it extracts a signal for which no correction is needed in the equalization circuit. On the other hand, the low-frequency extraction unit extracts a signal which is to be amplified by the equalization circuit. In so doing, used are such a cutoff frequency as not to effect on the vocal band in the high-frequency side and a filter, having a steep characteristic, set to an attenuation slope. Furthermore, in order to reduce the dip, namely in order to reduce the phase difference with the output signal from the high-frequency extraction unit, filters of filter order corresponding to a needed attenuation slope are not used and, instead thereof, two filters of filter order lower than them are used (hereinafter, these filter orders will be referred to as “first filter order” and “second filter order” and it is assumed herein that the first filter order is lower the second filter order). Then a cutoff frequency lower than the cutoff frequency in the low-pass extraction unit is set to a first low-pass filter whereas a cutoff frequency higher than the cutoff frequency in the low-frequency extraction unit is set to a second low-pass filter.

With this structure, in the low-frequency extraction unit the inputted signal passes through the first low-pass filter before it passes through the second low-pass filter. Note that, for the purpose of reducing the circuit scale, in the low-frequency unit the inputted signals are combined and then the above-described processing is performed. After the output signal of the low-frequency extraction unit is amplified, it is combined with a plurality of output signals of high-frequency extraction unit so as to be outputted from a speaker.

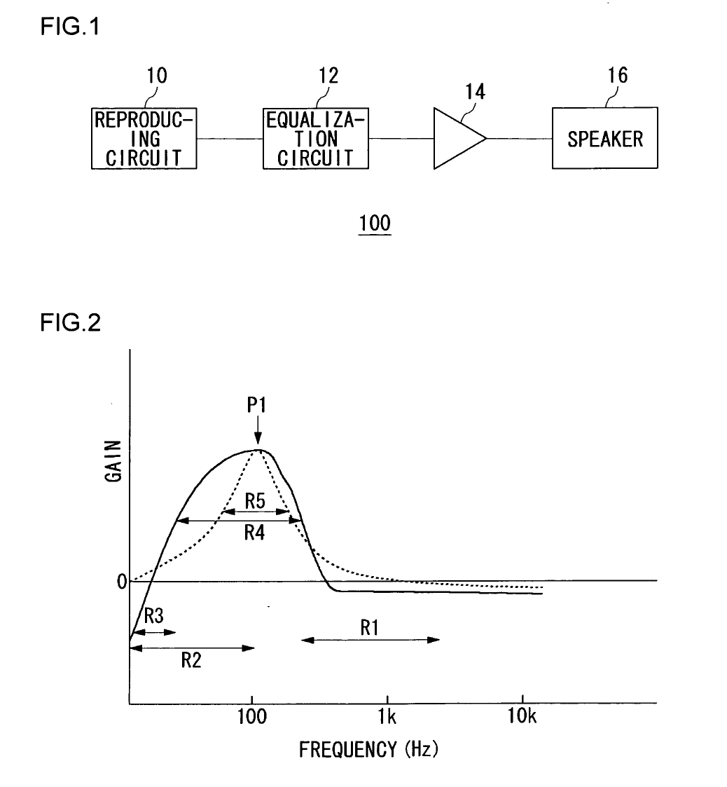

FIG. 1 illustrates a structure of an audio output apparatus 100 according to a first embodiment. The audio output apparatus 100 includes a reproducing circuit 10, an equalization circuit 12, an amplification unit 14 and a speaker 16. The audio output apparatus 100 may be a music reproducing apparatus, such as a compact disc player, which is itself capable of reproducing music independently, and it may reproduce audio by incorporating into a television receiver.

The reproducing circuit 10 reproduces audio based on predetermined data. In the television receiver, for example, the audio data contained in the received data are extracted and said audio data are outputted as electric signals. In a compact disc player, the music data recorded in a compact disc are picked up and said music data are outputted as electric signals. Though a signal outputted in the Figure is so indicated as to be transmitted through a single signal line, it is not limited thereto and there may be two signals where the audio is separated in the right and left sides to be reproduced in stereo.

The speaker 16 outputs finally the audio so that a user can catch it. For simplification of explanation, it is assumed here that the reproduction limit frequency is 100 MHz. In general, the speaker can output a signal, whose frequency is larger than the reproduction limit frequency, under a certain level of sound pressure. On the other hand, however, the sound pressure, at the time when a signal whose frequency is equal to or less than the reproduction limit frequency (hereinafter referred to as “bass region”) is outputted, drops drastically as the frequency drops. An amplification unit 14 for amplifying signals is provided at a preceding stage of the speaker 16. Though a single speaker 16 is shown in the Figure, it is assumed here that it is comprised of a combination of two speakers 16 corresponding to the stereo reproduction and one speaker 16 corresponding to the bass reproduction.

The equalization circuit 12 raises the sound pressure of a signal in a bass region to be reproduced by the speaker 16 in order to enhance a bass reproduction capacity in the audio output apparatus 100. Accordingly, the equalization 12 amplifies beforehand the signal of a bass region. That is, the signal is given a frequency characteristic opposite to that of the speaker 16. However, in order to reduce the bass distortion emerging at about 10 Hz, the signal having a component of frequency in which the bass distortion is to emerge (hereinafter referred to as “super bass region”) is not amplified. It is to be noted that a frequency bandwidth to be amplified in a bass region is called “bass reproduction band”. Here, the broader the bass reproduction band, the better it is in order to raise the sound quality of bass. The equalization circuit 12 amplifies the signal in the bass region but so operates as to reduce the effect on the signal in a vocal band.

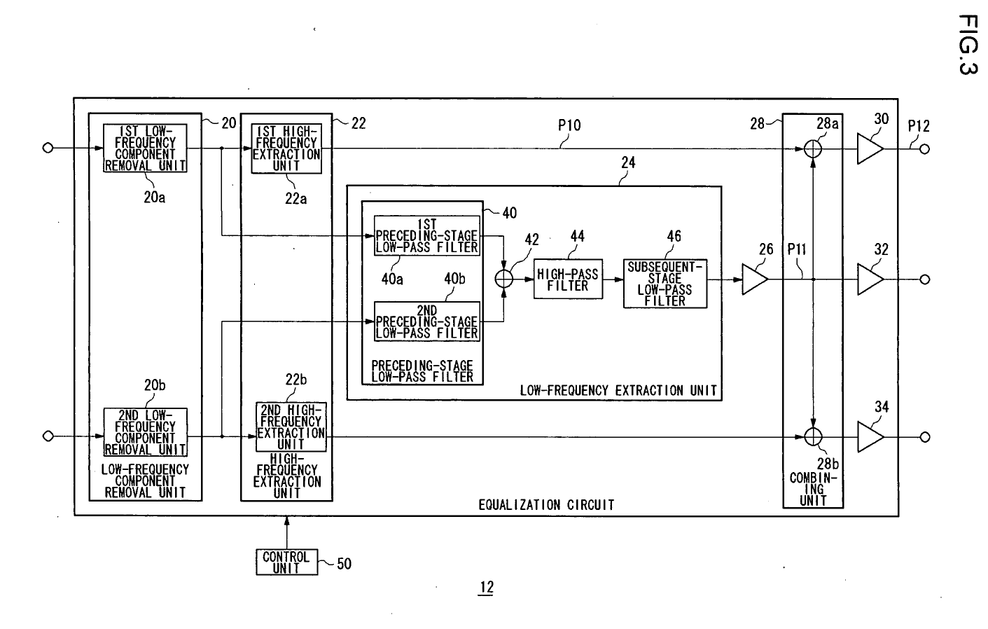

FIG. 2 shows a frequency characteristic of an equalization circuit 12. The solid line in the Figure is a frequency characteristic of the equalization circuit 12. The dotted line in the Figure, on the other hand, is a frequency characteristic of an equalizer which is devoid of the structure described later. Here, “P1” indicates a “reproduction limit frequency”, “R1” a “vocal band”, “R2” a “bass region”, “R3” a “super bass region”, and “R4” and “R5” are each a “bass reproduction band”. The characteristics of the equalization circuit 12 shown in FIG. 2 will be described after the structure of the equalization circuit 12 is explained.

FIG. 3 shows a structure of an equalization circuit 12. The equalization circuit 12 includes a first low-frequency component removal unit 20a and a second low-frequency component removal unit 20b, which are generically referred to as a low-frequency removal unit 20, a first high-frequency extraction unit 22a and a second high-frequency extraction unit 22b, which are generically referred to as a high-frequency extraction unit 22, a low-frequency extraction unit 24, an amplification unit 26, a first combining unit 28a and a second combining unit 28b, which are generically referred to as a combining unit 28, a buffer 30, a buffer 32, a buffer 34, and a control unit 50. The low-frequency extraction unit 24 includes a first preceding-stage low-pass filter 40a and a second preceding-stage low-pass filter 40b, which are generically referred to as a preceding-stage low-pass filter 40, a combining unit 42, high-pass filter 44, and a subsequent-stage low-pass filter 46. It is assumed here that a right-side audio signal and a left-side audio signal are inputted from the reproducing circuit 10 for stereo reproduction.

In order to reduce the bass distortion, the low-frequency component removal unit 20 outputs a signal in which the super bass region has been attenuated from an inputted audio signal. Used here is a first-order high-pass filter in which the minimum frequency to be reproduced by the speaker 16 is set as the cutoff frequency.

The high-frequency extraction unit 22 extracts, from the signal outputted from the low-frequency component removal unit 20, a signal whose frequency component is equal to or greater than the reproduction limit frequency. That is, the signal on which basically no processing is to be performed is extracted as a signal in the frequency domain which can be reproduced by the speaker 16 without problems. Used here is a second-order high-pass filter whose reproduction limit frequency is set to the cutoff frequency.

The preceding-stage low-pass filter 40 and the subsequent-stage low-pass filter 46 extract, from the signal outputted from the low-frequency component removal unit 20, the components of signal other than that extracted by the high-frequency extraction unit 22. This signal is amplified to enhance the bass reproduction capability. The cutoff frequency (hereinafter referred to as cutoff frequency for separation) as the low-frequency extraction unit 24 including the preceding-stage low-pass filter 40 and the subsequent-stage low-pass filter 46 must be specified based on the reproduction limit frequency and the vocal band, and the frequency characteristics of signal outputted finally from the equalization circuit 12 will be so determined as to become the solid line of FIG. 2. It is assumed herein that an appropriate cutoff frequency for separation is set beforehand by an experimental result or the like. Also, in accordance with the cutoff frequency for separation, the attenuation slope of the low-frequency extraction unit 24 must be so specified as not to affect the signal outputted from the high-frequency extraction unit 22. And it is assumed here that said attenuation slope and the filter order of a low-pass filter corresponding thereto (hereinafter referred to as “final filter order”) are set beforehand by an experimental result or the like.

The cutoff frequency of the preceding-stage low-pass filter 40 is set to a frequency lower than the cutoff frequency for separation whereas the cutoff frequency of the subsequent-stage low-pass filter 46 is set to a frequency higher than the cutoff frequency for separation. Here, the cutoff frequency for separation is set to a “frequency higher than the reproduction limit frequency” and therefore the cutoff frequency of the preceding-stage low-pass filter 40 is set to the “reproduction limit frequency”. On the other hand, the filter order of the preceding-stage low-pass filter 40 is set to the first filter order which is smaller than the final filter order whereas the filter order of the subsequent-stage low-pass filter 46 is set to the second filter order which is smaller than the final filter order. The first filter order is smaller than the second filter order, and the filter order is set so that the sum of the first filter order and the second filter order equals the final filter order. Here, in order to satisfy the “fifth order” of the order necessary of the final filter, the first filter order is set to “2” and the second filter order is set to “3”. Note that the base reproduction band can be enlarged if the cutoff frequency of the low-frequency component removal unit 20 is set lower and the cutoff frequency for separation of the low-frequency extraction unit 24 is set higher.

The signal outputted from the low-frequency component removal unit 20 passes through the preceding-stage low-pass filter 40 and the subsequent-stage low-pass filter 46 in this order. The combining unit 42 combines the outputs of the preceding-stage low-pass filter 40. Since the sound image localization of bass is set in the center, no problem results even if the signal processing is carried out in the state where they are added up. There are cases where DC components are contained in the signal combined by the combining unit 42, so that the high-pass filter 44 removes the DC components. Similar to the low-frequency component removal unit 20, a first-order high-pass filter in which the minimum frequency to be reproduced by the speaker 16 is set as the cutoff frequency is used here.

The amplification unit 26 amplifies the signals outputted from the low-frequency extraction unit 24. The combining unit 28 combines the signal outputted from the high-frequency extraction unit 22 with the signal outputted from the amplification unit 26. The buffer 30 performs buffering of the signals combined by the first combining unit 28a, the buffer 32 performs buffering of the signals amplified by the amplification unit 26, and the buffer 34 performs buffering of the signals combined by the second combining unit 28b. Finally, the signals are outputted as a left-side signal from the buffer 30, as a right-side output from the buffer 34 and a bass output from the buffer 32.

The control unit 50 receives, from a user via an input interface (not shown in the Figure), instructions on the characteristics of signals to be extracted by the high-frequency extraction unit 22 and low-frequency extraction unit 24, such as the cutoff frequency, the Q value and the gain of the high-frequency extraction unit 22, preceding-stage low-pass filter 40, high-pass filter 44 and subsequent-stage low-pass filter 46. Furthermore, the control unit 50 converts this instruction into a predetermined digital data word and then, based on this digital data word, the control unit 50 electronically controls the setting of the high-frequency extraction unit 22, preceding-stage low-pass filter 40, high-pass filter 44 and subsequent-stage low-pass filter 46.

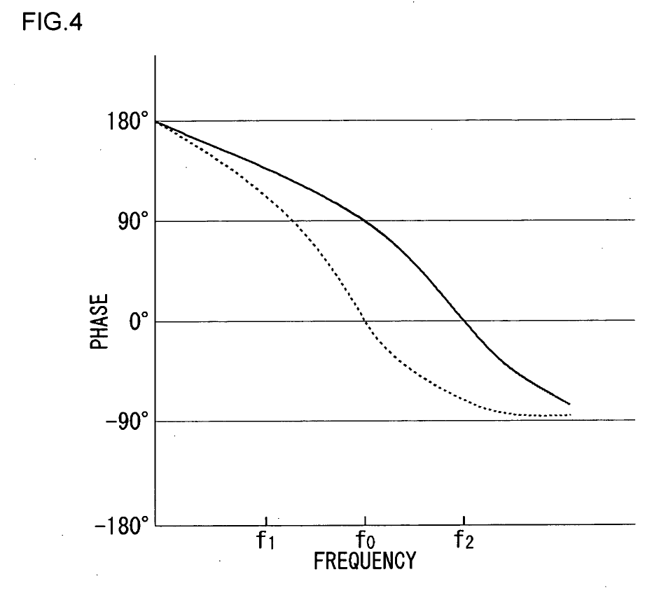

FIG. 4 shows a relation of the frequency characteristics to the phase shift in the preceding-stage low-pass filter 40 and subsequent-stage low-pass filter 46. Here, to facilitate the explanation, the order of a filter corresponding to the preceding-stage low-pass filter 40 is set to the “first order” and the order of a filter corresponding to the subsequent-stage low-pass filter 46 is set to the “second order”, and the phase characteristic in this case is shown as the solid line. On the other hand, the case where a higher-order filter is of the “third order” is shown as the dotted line. The frequency “f0” in the Figure is the cutoff frequency of a third-order filter, the frequency “f1” is the cutoff frequency of a first-order filter corresponding to the preceding-stage low-pass filter 40, and the frequency “f2” is the cutoff frequency of a second-order filter corresponding to the subsequent-stage low-pass filter 46. As shown in the Figure, the phase shift can be made smaller by combining the filters of low filter order whose cutoff frequency differ. In the combination of the filters, lowering further the cutoff frequency of the filter of lower filter order can reduce further the phase shift at the low frequency. At the same time, though the phase shift at the high frequency becomes larger, the output gain from the low-frequency extraction unit 24 becomes smaller at the high frequency over the vocal band as shown in FIG. 2 and therefore the effect by such the phase shift will be small.

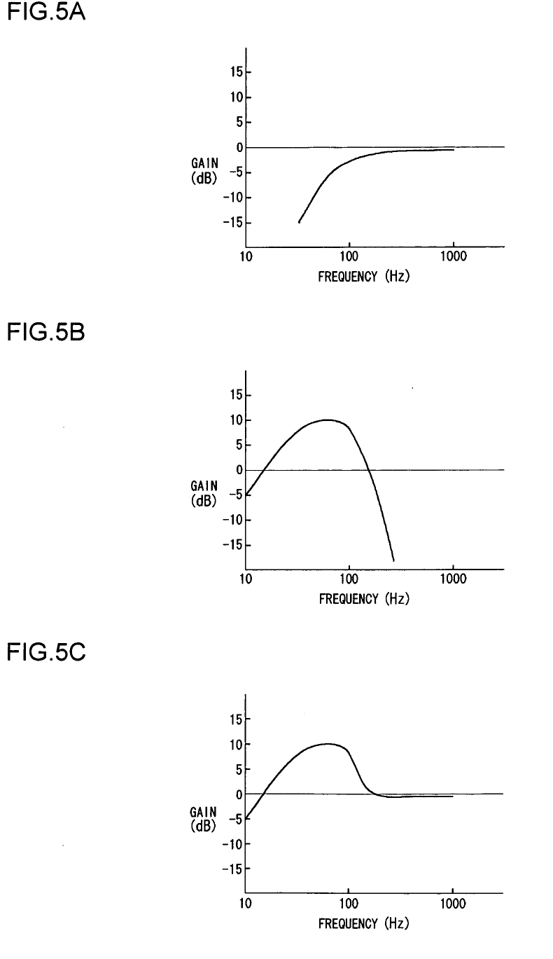

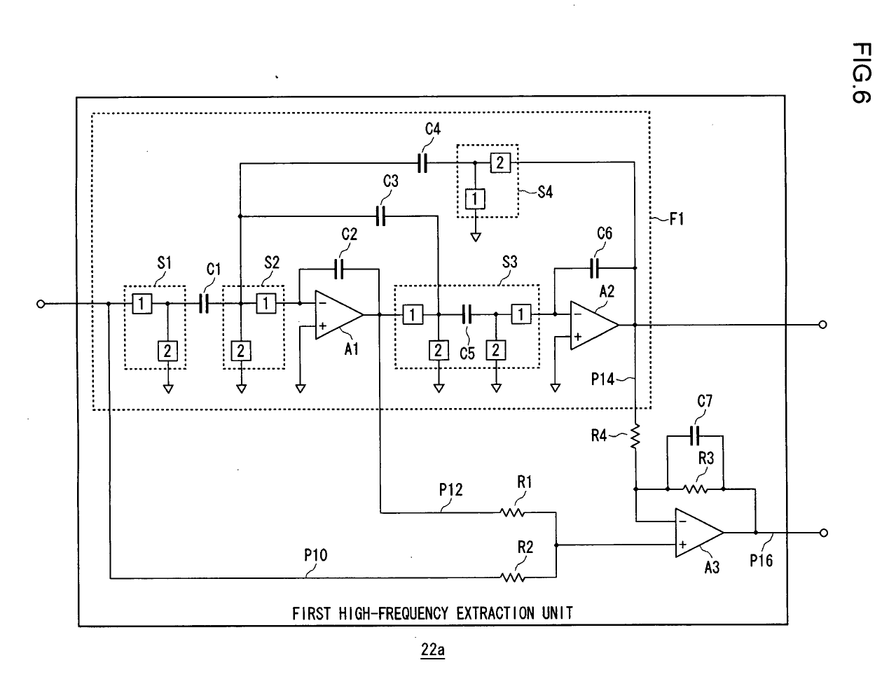

FIGS. 5A to 5C show frequency characteristics of the equalization circuit 12. FIG. 5A shows a frequency characteristic at “P10” of FIG. 3, namely the frequency characteristic of an output signal of the high-frequency extraction unit 22. FIG. 5B shows a frequency characteristic at “P11” of FIG. 3, namely the frequency characteristic of an output signal of the amplification unit 26. FIG. 5C shows a frequency characteristic at “P12” of FIG. 3, namely the frequency characteristic of an output signal of the buffer 30. As shown in the Figures, FIG. 5C is obtained in a synthesized form of FIG. 5A and FIG. 5B. As a result, the gain of a super bass region is small and a bass reproduction band is broadened as shown in FIG. 5B. Comparing FIG. 5A with 5B indicates clearly that the effect on the vocal band is small and the dip is small. The same frequency characteristic as FIG. 5C is indicated as the solid line in FIG. 2. As compared with the frequency characteristic indicated in the dotted line, the gain of a super bass region is smaller, the bass reproduction band is broader, the effect on the vocal band is small and the dip is also smaller.

According to the embodiment of the present invention, a low-pass filter by which to separate the signals to be amplified is structured by combining a plurality of filters having low filter order. Hence, the phase difference from signals which are not be amplified becomes small and the dip becomes small. Also, it is structured by a high-pass filter for removing a super bass region and a low-pass filter for separating the signals to be amplified. Hence, the bass reproduction band can be broadened. Also, the low-pass filter for separating the signals to be amplified is comprised of a filter whose attenuation slope is large. Thus, the effect on the vocal band can be made smaller. Also, since the processing for the bass region is performed on the combined signal, the circuit scale can be reduced.

### Second Embodiment

A second embodiment of the present invention relates to a high-pass filter used in the equalization circuit of the first embodiment. As already explained in the first embodiment, the smaller the enclosure of a speaker, the higher the reproduction limit frequency becomes. As a result, the signal with a frequency lower than the reproduction limit frequency causes a bass distortion, which in turn reduces the sound quality of audio reproduced from the speaker. In light of this, the present embodiment relates to a high-pass filter that cuts off the signal with a frequency lower than the reproduction limit frequency of a speaker.

In a speaker where the enclosure's capacity is small, it is generally required that a reproducing device attached to a speaker, such as a preamplifier, be smaller in size, more specifically, the high-pass filter be made smaller in size and made into an IC. One of filters suitable for IC packaging is a filter using a switched-capacitor equivalent circuit or the like. However, in the signal with a frequency which is higher to some extent as compared with the sampling frequency of a switched capacitor equivalent circuit, a distortion is caused by the effect of the sampling frequency. Hence, if the switched-capacitor equivalent circuit is directly used as the high-pass filter, the signal outputted will suffer from distortion.

In the light of this, according to the present embodiment, the switched-capacitor equivalent circuit is incorporated as a resistor of a biquad filter. And a signal with low-pass characteristics and a signal with band-pass characteristics are extracted from the inputted signal and then, by subtracting these extracted signals from the inputted signal, a signal with high-pass characteristics in the inputted signal is extracted. The signal outputted from the switched-capacitor equivalent circuit corresponds to the signal with low-pass characteristics and the signal with band-pass characteristics and therefore its frequency is lower, to some extent, than the sampling frequency. As a result, the signal distortion due to the sampling can be restricted.

FIG. 6 shows a structure of the first high-frequency extraction unit 22a according to the second embodiment of the present invention. The first high-frequency extraction unit 22a includes a filter F1, operational amplifiers A1 to A3, capacitors C1 to C7, switches S1 to S4, and resistors R1 to R4.

Here, the processing contents of the first high-frequency extraction unit 22a will be described based on the following equation. The transfer function of a second-order high-pass filter is expressed as follows, where an input signal is Vin and an output signal is Vout.

$$\frac{Vout}{Vin} = \frac{{s}^{2}}{{s}^{2} + as + b} \qquad ( Eq . 1 )$$

where a and b are predetermined constants. Rewriting this, the following is obtained.

$$\frac{Vout}{Vin} = \frac{{s}^{2} + as + b}{{s}^{2} + as + b} - \frac{as}{{s}^{2} + as + b} - \frac{b}{{s}^{2} + as + b} \qquad ( Eq . 2 )$$

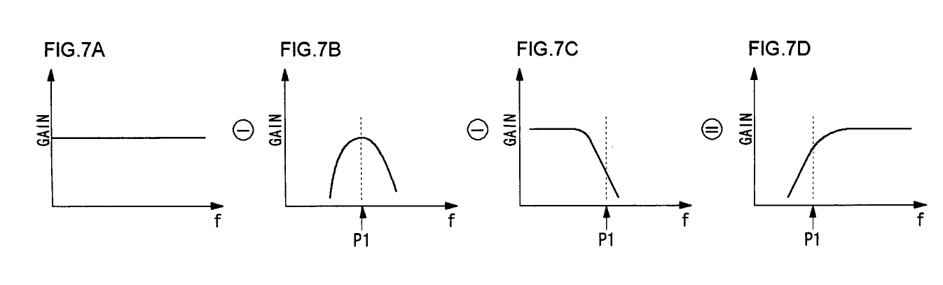

That is, the transfer function of a second-order high-pass filter is expressed by an input signal in the first term, an output signal of a band-pass filter in the second term, namely a signal with band-pass characteristics, and an output signal of a low-pass filter in the third term, namely a signal with low-pass characteristics. A signal with high-pass characteristics is obtained by subtracting the signal with band-pass characteristics and the signal with low-pass characteristics from the input signal. The first high-frequency extraction unit 22a performs such processing as this, and the response thereto will be explained with reference to FIGS. 7A and 7B. FIGS. 7A and 7B show frequency characteristics at P10 to P16 of FIG. 6. FIG. 7A shows the frequency characteristics of a input signal as it is, the input signal being a signal at P10 of FIG. 6. For simplicity of description, it was shown here that the gain of the input signal is constant in a predetermined range of frequencies. However, the characteristics thereof may be such that the gain increases or decreases at a predetermined frequency, for instance.

FIG. 7B shows the frequency characteristics of a signal where the signal at P12 of FIG. 6 is inverted. As shown in the Figure, FIG. 7B concerns a signal with band-pass characteristics and therefore the signal at P12 of FIG. 6 may be said to be a signal where the signal with band-pass characteristics is inverted. FIG. 7C concerns a signal at P14 of FIG. 6 and shows the frequency characteristics of a signal with low-pass characteristics. Among these signals, the signal at P10 and the signal at P12 are combined together at a stage prior to an noninverting input terminal of an operational amplifier A3, and the combined signal is inputted to the noninverting input terminal of the operational amplifier A3 and the signal at P14 is inputted to an inverting input terminal of the operational amplifier A3. As a result, an output signal, or the signal at P16, from the operational amplifier A3 is obtained by subtracting the signal with band-pass characteristics and the signal with low-pass characteristics from the input signal. As shown, FIG. 7D shows the frequency characteristics of a signal with high-pass characteristics. Note that the aforementioned reproduction limit frequency P1 is indicated as P1 in FIGS. 7B to 7D. The reason why the relationship between the first high-frequency extraction unit 22a and P1 was set as shown in Figure will be explained later.

Refer back to FIG. 6. In switches S1 to S4, “1” and “2” enclosed by the square is selected alternately. That is, with the error in timing being ignored, at a certain timing “1's” in the switches S1 to S4 are turned on and “2's” are turned off. At another timing, “2's” in the switches S1 to S4 are turned on and “1's” are turned off. A combination of two “1's” and “2's” held among the capacitor C1, the capacitor C5 and the capacitor C4, namely a pair of switch S1 and switch S2 and a pair of switch S4 and switch S2, and the switch S3 each contains a capacitor therein and constitutes a switched-capacitor equivalent circuit. In the case of a switched-capacitor equivalent circuit configured by a combination of the switch S1, the capacitor C1 and the switch S2, an equivalent resistance Reff due to the switched-capacitor equivalent circuit is expressed as follows if the sampling period for switching “1's” and “2's” of the switch S1 and the switch S2 is denoted by T.

$$Reff = \frac{T}{{C}_{1}} \qquad ( Eq . 3 )$$

The similar relation holds in the other switched-capacitor equivalent circuits and each of those circuits operates as a resistor. The combination of the switch S1, the capacitor C1 and the switch S2 not only operates as a resistor but also inverts the phase of an inputted signal. The operational amplifier A1, the capacitor C2 and the capacitor C3 constitute a band-pass filter, and the output signal at P12 becomes a signal in which the signal with band-pass characteristics has been inverted, as described above. The switch S3 operates as a resistor and also inverts the signal outputted from the operational amplifier A1. The operational amplifier A2 and the capacitor C6 constitute a low-pass filter, and the output signal at P14 becomes a signal with low-pass characteristics, as described above. Then the signal with low-pass characteristics is fed back to the operational amplifier A1 via the switch S4 and the capacitor C4.

By employing the above structure, a filter F1 in the Figure constitutes a biquad filter and so operates as to output the signal, in which the signal with band-pass characteristics has been inverted, and the signal with low-pass filters. Here, the sampling frequency which is the inverse of sampling period T is set to a frequency higher than the reproduction limit frequency P1 of the speaker 16 (not shown). This is because in general the outputted signal suffers from distortion due to the sampling unless the signal has a frequency lower than the sampling frequency to some extent. Furthermore, it is assumed that each component of the filter F1 is so set as to extract a signal, in which a signal with band-pass characters to be cut off by a frequency in the vicinity of the reproduction limit frequency P1, and a signal with low-pass characteristics.

The combinations of “1” and “2” are mutually the same in the pair of switch S1 and switch S2 and the switch S3. In comparison with this, the combinations of “1” and “2” in the pair of switch S2 and switch S4 are opposite. That is, the phase of a signal is inverted in the pair of switch S1 and switch S2, and the switch S3, whereas the phase of a signal is not inverted in the pair of switch S2 and switch S4. With the structure like this, although, in the normal biquad filter, three operational amplifiers are required to extract a signal with band-pass characters and a signal with low-pass characters from an input signal, the filter is constituted by two operational amplifiers suffice here. Note that the combination of switch S2 and switch S4 may invert the phase of a signal instead of the structure where the combination of switch S1 and switch S2 inverts the phase of a signal.

The operational amplifier A3, the resistors R1 to R4 and the capacitor C7 attenuate a component of the signal with low-pass characteristics and a component of the signal with band-pass characteristics from the input signal and then extracts a signal with high-pass characteristics in the input signal. Since the signal with low-pass characteristics and the signal with band-pass characteristics are cut off by a frequency in the vicinity of the reproduction limit frequency P1, the signal with high-pass characteristics will be a signal whose frequency is equal to or greater than the reproduction limit frequency P1.

Similar to FIG. 3, a control unit 50 may be provided inside or outside the first high-frequency extraction unit 22a. The control unit 50 receives, from a user via an input interface (not shown in the Figure), instructions on a frequency, in the vicinity of the reproduction limit frequency, to be cut off by the first high-frequency extraction unit 22a as well as the sampling frequency. Furthermore, the control unit 50 converts this instruction into a predefined digital data word and then, based on this digital data word, the control unit 50 electronically controls the setting of the first high-frequency extraction unit 22a.

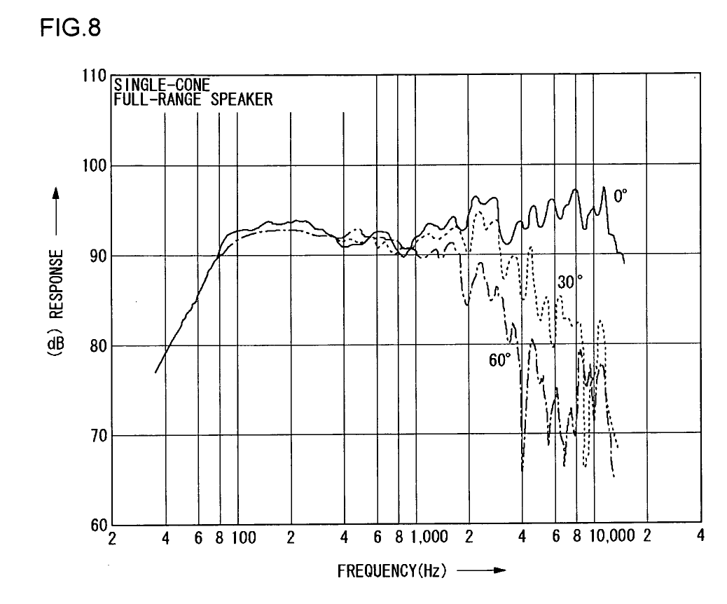

Here, the frequency to be cut off by the first high-frequency extraction unit 22a is set to the vicinity of 100 Hz, for instance. This is set in consideration of the reproduction limit frequency of the speaker 16, and a description will be given of the reproduction limit frequency of the speaker 16, based on an example of speaker characteristics. In FIG. 8, the horizontal axis indicates the frequency and the vertical axis the response. As shown in the Figure, when the frequency becomes below 100 Hz, the response drops drastically. Note that the response is a value measured in a manner such that the sound pressure level at a point of 1 m on a reference axis becomes a continuous curve in correspondence to the frequency. In the above case, the distortion in a mechanical system of the speaker 16 increases in a frequency band lower than 100 Hz. As a result, according to the present embodiment the frequency band like this is cut off by a high-pass filter.

A reproduction limit frequency f0 of a speaker 16 is determined by an enclosure volume V of the speaker 16, an effective vibration radius a, an equivalent mass mo of the vibration system and a prescribed constant □, as follows.

$${f}_{0}^{2} = \frac{355 \times {a}^{4}}{α \times V \times mo} \qquad ( Eq . 4 )$$

That is, the reproduction limit frequency f0 increases when the effective vibration radius a increases, the enclosure volume V of the speaker 16 diminishes and the equivalent mass mo of the vibration system diminishes. When the reproduction limit frequency f0 increases, the frequency to be cut off by the first high-frequency extraction unit 22a increases, too.

According to the present embodiment, part of frequency band incapable of being reproduced by the speaker in the signals to be reproduced by the speaker is cut off beforehand by the high-pass filter, so that the distortion possibly caused in the speaker can be reduced. Since switched-capacitor equivalent circuits are used, the filter can be made smaller in size. Since the switched-capacitor equivalent circuits are used for the extraction of the signal with low-pass characteristics and the signal with band-pass characteristics of a biquad filter, the distortion in the signal with high-pass characteristics based on the sampling can be reduced. Also, the sound quality of audio reproduced by the speaker can be improved.

### Third Embodiment

Similar to the second embodiment, a third embodiment of the present invention relates to a high-pass filter. In the second embodiment, a description is given of the second-order high-pass filter. Here the third embodiment relates to a first-order high-pass filter and a predetermined higher-order high-pass filter which combines the first-order high-pass filter and the second high-pass filter in an arbitrary manner.

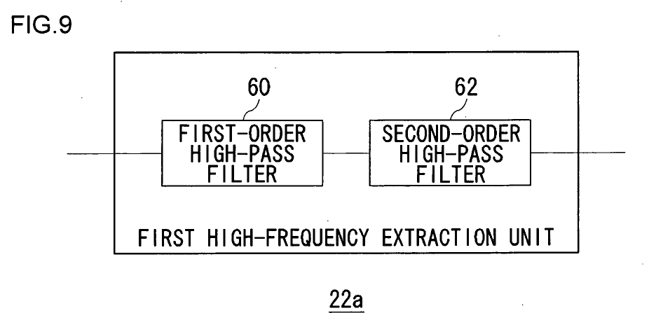

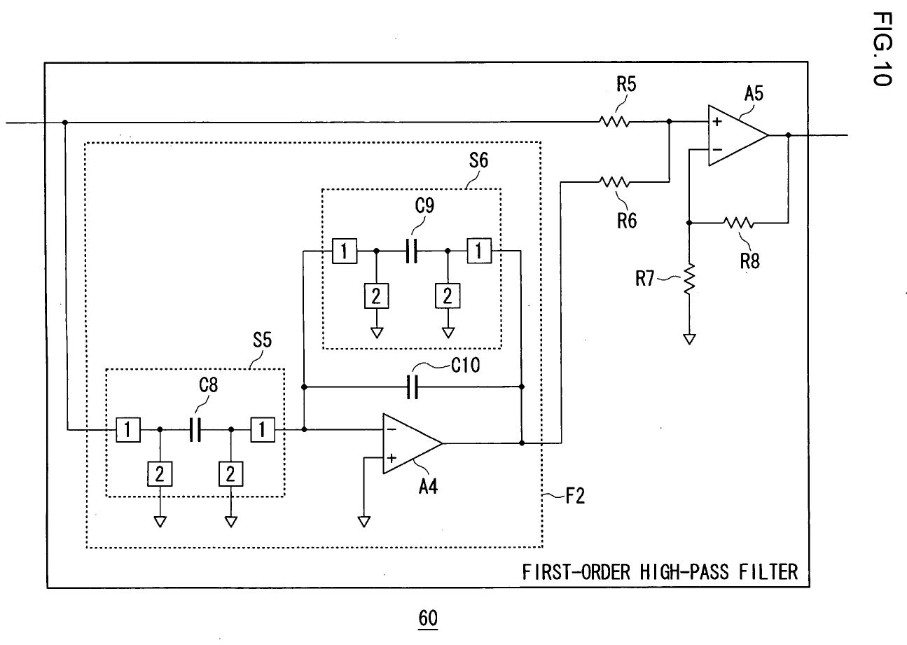

FIG. 9 shows a structure of a first high-frequency extraction unit 22a according to the third embodiment of the present invention. The first high-frequency extraction unit 22a includes a first-order high-pass filter 60 and a second-order high-pass filter 62. The second-order high-pass filter has the similar structure to that of the first high-frequency extraction unit 22a in the second embodiment, the description thereof is omitted here.

Similar to the second-order high-pass filter 62, the first-order high-pass filter 60 is a high-pass filter but the filter order thereof is of the first order. As a result, the first high-frequency extraction unit 22a is the high-pass filter of the third order. In this manner, an arbitrary number of second-order high-pass filters and first-order high-pass filters are connected in series so as to be able to realize a high-pass filter of an arbitrary order.

FIG. 10 shows a structure of the first-order high-pass filter 60. The first-order high-pass filter 60 includes a filter F2, an operational amplifier A4, an operational amplifier A5, capacitors C8 to C10, a switch S5, a switch S6 and resistors R5 to R8.

The filter F2 is a first incomplete integrator comprised of the switch S5, the switch S6, the capacitor C10 and the operational amplifier A4, and operates as a low-pass filter. That is, the filter F2 outputs a signal in which the signal with low-pass characteristics of an inputted signal is inverted. Here, the filter F2 is constituted by the switch S5 and the switch S6 which are to operate resistors, contained in the first-order incomplete integrator, at a predetermined sampling frequency. The sampling frequency is set to a frequency higher than the reproduction limit frequency of the speaker 16 (not shown). The signal in which the signal with low-pass characteristics extracted by the filter F2 is inverted is cut off by a frequency in the vicinity of the reproduction limit frequency of the speaker 16.

The operational amplifier A5 and the resistors R5 to R8 extract a signal obtained by subtracting a component of the signal with low-pass characteristics from the inputted signal, namely a signal with high-pass characteristics of the inputted signal. Finally, the first-order high-pass filter 60 extracts signals with high-pass characteristics whose frequency is equal to or higher than the reproduction limit frequency of the speaker 16.

According to the present embodiment, a switched-capacitor equivalent circuit is used, so that the size of a filter can be easily reduced. Also, since the switched-capacitor equivalent circuit is used to extract a signal with low-pass characteristics of a first-order incomplete integrator, the distortion in the signal with high-pass characteristics can be reduced. Furthermore, a filter of a predetermined order can be realized by arbitrarily combining the first-order filter and the second-order filter.

### Fourth Embodiment

A fourth embodiment of the present invention relates to a dividing-network circuit to which the high-pass filter described in the second and the third embodiment is applied. The dividing-network circuit divides a signal, to be reproduced by a speaker, into a plurality of frequency bands, and is comprised of a plurality of dedicated speakers associated with the plurality of frequency bands. The signal to be reproduced by the speaker is converted to the signals of respective frequency bands by a filter. In so doing, the high-pass filter described in the second and the third embodiment is used.

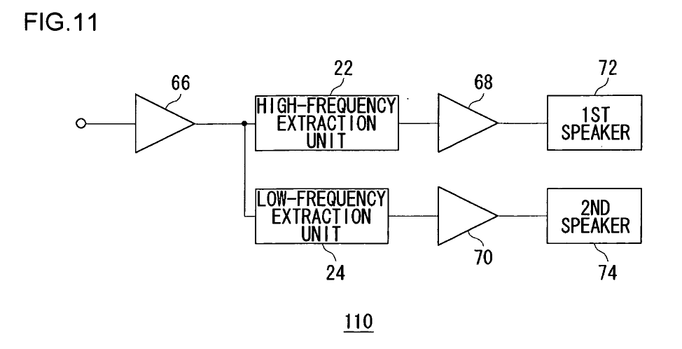

FIG. 11 shows a structure of an audio output apparatus 110 according to the fourth embodiment of the present invention. The audio output apparatus 100 includes an amplifier 66, a high-frequency extraction unit 22, a low-frequency extraction unit 24, an amplifier 68, an amplifier 70, a first speaker 72 and a second speaker 74.

The amplifier 66 amplifies signals to be reproduced. The high-frequency extraction unit 22 extracts high-pitched sound components in the amplified sounds. Accordingly, the applicable sounds are extracted by the high-pass filter as described in the second or the third embodiment. In so doing, the frequency to be cut off by the high-frequency extraction unit 22 is set to about 100 Hz as described above. The sounds extracted by the high-frequency extraction unit 22 are amplified by the amplifier 68 and reproduced by the first speaker 72. On the other hand, the low-frequency extraction unit 24 extracts low-mid sound components in the amplified sounds. Accordingly, the applicable sounds are extracted by the low-pass filter. The sounds extracted by the low-frequency extraction unit 24 are amplified by the amplifier 70 and reproduced by the second speaker 74.

According to the present embodiment, the high-pass filter is applicable to the dividing-network circuit that performs the bandwidth dividing drive.

The present invention has been described based on the embodiments. These embodiments are merely exemplary, and it is understood by those skilled in the art that various modifications to the combination of each component and process thereof are possible and that such modifications are also within the scope of the present invention.

In the first embodiment, the low-frequency extraction unit 24 is configured such that the high-pass filter 44 and the subsequent-stage low-pass filter 46 are arranged in this order. However, it is not limited thereto and, for example, it may be configured such that the subsequent-stage low-pass filter 46 and the high-pass filter 44 are arranged in this order, and it may also be comprised of a band-pass filter having the similar characteristics. According to this modification, the same characteristics can be obtained with different circuit configurations. That is, it suffices as long as desired characteristics are obtained.

In the first embodiment, the equalization circuit 12 inputs a plurality of signals and outputs a plurality of signals. However, it is not limited thereto and, for example, it may input a single signal and output a single signal. In this case, the low-frequency component removal unit 20, the high-frequency extraction unit 22, the preceding-stage low-pass filter 40 and the combining unit 28 may each contain a single component. The combining unit 42 may not be provided at all. According to this modification, the circuit configuration can be further reduced in size. That is, depending on whether the audio is to be reproduced in stereo or monaural, it is only necessary to provide a structure suitable thereto.

In the second embodiment, the filter F1 is a biquad filter. However, it is not limited thereto and, for example, the filter F1 may be a filter other than the biquad filter. According to this medication, various types of filters can be used. That is, it is only necessary that the filter F1 outputs a signal, in which a signal with band-pass characteristics is inverted, and a signal with low-pass characteristics.

Additional embodiments combining arbitrarily the first embodiment to the fourth embodiment may also be effective. According to this modification, the advantages by combining arbitrarily the first embodiment to the fourth embodiment can be provided.

What is claimed is:

1. A filter circuit, comprising:
an input unit which inputs a signal to be processed;
a first extraction unit which passes the inputted signal through a filter and which extracts a signal with low-pass characteristics and a signal with band-pass characteristics in the inputted signal; and
a second extraction unit which attenuates a component of the extracted signal with low-pass characteristics and a component of the extracted signal with band-pass characteristics from the inputted signal and which extracts a signal with high-pass characteristics in the inputted signal,
wherein said first extraction unit is comprised of a switched-capacitor equivalent circuit which is to operate a resistor contained in the filter at a predetermined sampling frequency, said sampling frequency is set to a frequency higher than a reproducible frequency of a speaker provided at a subsequent stage, and the filter is so set as to extract the signal with low-pass characteristics and the signal with band-pass characteristics to be cut off by a frequency in the vicinity of the reproducible frequency of a speaker, and
wherein, based on the signal with low-pass characteristics and the signal with band-pass characteristics, said second extraction unit extracts the signal with high-pass characteristics whose frequency is equal to or higher than the reproducible frequency of a speaker.

2. A filter circuit according to claim 1, wherein a filter in said first extraction unit is a biquad filter.

3. A filter circuit according to claim 2, wherein the biquad filter in said first extraction unit includes:
a first switched-capacitor equivalent circuit which allows passage of the inputted signal;
a first operation amplifier which extracts the signal with band-pass characteristics from the signal passed through the first switched-capacitor equivalent circuit;
a second switched-capacitor equivalent circuit which allows passage of the extracted signal with band-pass characteristics;
a second operation amplifier which extracts the signal with low-pass characteristics from the signal passed through the second switched-capacitor equivalent circuit; and
a third switched-capacitor equivalent circuit which allows passage of the extracted the signal with low-pass characteristics and feeds back the signal passed therethrough to the first operational amplifier,
wherein when the first switched-capacitor equivalent circuit and the second switched-capacitor equivalent circuit invert the phase of the signal passed therethrough, the third switched-capacitor equivalent circuit is so structured as not to invert the phase of the signal passed therethrough; and when the first switched-capacitor equivalent circuit and the second switched-capacitor equivalent circuit do not invert the phase of the signal passed therethrough, the third switched-capacitor equivalent circuit is so structured as to invert the phase of the signal passed therethrough.

4. A filter circuit according to claim 1, wherein the reproducible frequency of a speaker which is to serve as a reference for the sampling frequency in said first extraction unit is determined according to an enclosure volume of the speaker, and wherein as the enclosure of the speaker becomes smaller, the biquad filter is so set as to raise the frequency at which the signal with low-pass characteristics and the signal with band-pass characteristics are to be cut off.

5. A filter circuit, comprising:
an input unit which inputs a signal to be processed;
a first extraction unit which passes the inputted signal through a first-order incomplete integrator and which extracts a signal with low-pass characteristics in the inputted signal; and
a second extraction unit which attenuates a component of the extracted signal with low-pass characteristics from the inputted signal and which extracts a signal with high-pass characteristics in the inputted signal,
wherein said first extraction unit is comprised of a switched-capacitor equivalent circuit which is to operate a resistor, contained in the first-order incomplete integrator, at a predetermined sampling frequency, said sampling frequency is set to a frequency higher than a reproducible frequency of a speaker provided at a subsequent stage, and the first-order incomplete integrator is so set as to extract the signal with low-pass characteristics to be cut off by a frequency in the vicinity of the reproducible frequency of a speaker, and
wherein, based on the signal with low-pass characteristics, said second extraction unit extracts the signal with high-pass characteristics whose frequency is equal to or higher than the reproducible frequency of a speaker.

6. A filter circuit according to claim 1, further comprising a control unit which controls the frequency, in the vicinity of the reproducible frequency of a speaker, to be cut off by said first extraction unit.

7. A filter circuit according to claim 5, further comprising a control unit which controls the frequency, in the vicinity of the reproducible frequency of a speaker, to be cut off by said first extraction unit.

8. A filter circuit according to claim 6, further comprising:
a receiving unit which receives from a user an instruction on the frequency, in the vicinity of the reproducible frequency of a speaker, to be cut off by said first extraction unit; and
a conversion unit which converts the received instruction into a digital data word,
wherein, based on the digital data word converted, said control unit controls the frequency, in the vicinity of the reproducible frequency of a speaker, to be cut off by said first extraction unit.

9. A filter circuit according to claim 7, further comprising:
a receiving unit which receives from user an instruction on the frequency, in the vicinity of the reproducible frequency of a speaker, to be cut off by said first extraction unit; and
a conversion unit which converts which converts the received instruction into a digital data word,
wherein, based on the digital data word converted, said control unit controls the frequency, in the vicinity of the reproducible frequency of a speaker, to be cut off by said first extraction unit.

10. A filter circuit including one or more first-order high-pass filters and one or more second-order high-pass filters,
wherein said second-order high-pass filter extracts a signal with low-pass characteristics and a signal with band-pass characteristics and attenuates a component of the extracted signal with low-pass characteristics and a component of the extracted signal with band-pass characteristics so as to extract a signal with high-pass characteristics, and said second-order high-pass filter includes a resistor comprised of a switched-capacitor equivalent circuit which is to operate at a predetermined sampling frequency,
wherein said first-order high-pass filter extracts a signal with high-pass characteristics by a first-order incomplete integrator and attenuates a component of the extracted signal with low-pass characteristics so as to extract a signal with high-pass characteristics, and said first-order high-pass filter is comprised of a switched-capacitor equivalent circuit which is to be operate a resistor, included in the first-order incomplete integrator, at a predetermined sampling frequency, and
wherein the sampling frequency to be set in said one or more first-order high-pass filters and said one or more second-order high-pass filters is set to a frequency higher than a reproducible frequency of a speaker provided at a subsequent stage, and said one or more first-order high-pass filters and said one or more second-order high-pass filters are connected in series and extract the signal with high-pass characteristics whose frequency is equal to or higher than the reproducible frequency of a speaker.

11. A filter circuit according to claim 10, wherein said second-order high-pass filter includes a biquad filter.

12. A reproduction apparatus, comprising:
an input unit which inputs a signal to be processed;
a high-frequency extraction unit which extracts, from the inputted signal, a signal with high-pass characteristics whose frequency is equal to or higher than a reproducible frequency of a speaker provided at a subsequent stage;
an amplification unit which amplifies the extracted signal with high-pass characteristics; and
a speaker which reproduces the amplified signal as an audio signal,
said high-frequency extraction unit including:
a first extraction unit which passes the inputted signal through a filter and which extracts a signal with low-pass characteristics and a signal with band-pass characteristics in the inputted signal; and
a second extraction unit which attenuates a component of the extracted signal with low-pass characteristics and a component of the extracted signal with band-pass characteristics from the inputted signal and which extracts a signal with high-pass characteristics in the inputted signal,
wherein the first extraction unit is comprised of a switched-capacitor equivalent circuit which is to operate a resistor contained in the filter is to be operated at a predetermined sampling frequency, said sampling frequency is set to a frequency higher than a reproducible frequency of said speaker, and the filter is so set as to extract the signal with low-pass characteristics and the signal with band-pass characteristics to be cut off by a frequency in the vicinity of the reproducible frequency of said speaker, and
wherein, based on the signal with low-pass characteristics and the signal with band-pass characteristics, the second extraction unit extracts the signal with high-pass characteristics whose frequency is equal to or higher than the reproducible frequency of said speaker.

13. A reproduction apparatus according to claim 12, wherein a filter in said first extraction unit is a biquad filter.
